(19) United States
(12) Patent Application Publication
(10) Pub. No.: US 2005/0206728 A1
(43) Pub. Date: Sep. 22, 2005

(54) Method and device for controlling a red light camera

(76) Inventor: Theodorus Maria Janssen, Spaarndam (NL)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/511,497

(22) PCT Filed: Apr. 15, 2003
(86) PCT No.: PCT/NL03/00289

§ 371 Date: Jun. 6, 2005

(30) Foreign Application Priority Data
Apr. 15, 2002 (NL) 1020385

(51) Int. Cl. H04N 7/18

(52) U.S. Cl. 348/149; 346/107.2; 340/937

(57) ABSTRACT

The invention relates to a method for controlling a red-light camera at a traffic light, the lights of which are formed by an array of intermittently operated LEDs. Vehicles which pass through the traffic light are detected and a recording is made when a vehicle passes during a period in which the red light of the traffic light is activated. There is herein detected for which part of the activation period the LEDs of the red light are actually on, and the recording is made in precisely that part of the activation period. The moment of the recording can further be corrected for a response time of the red-light camera. The invention further relates to a device for performing this method.

The invention relates to a method for controlling a red-light camera at a traffic light by detecting vehicles which pass through the traffic light and making at least one recording when a vehicle passes during a period in which the red light of the traffic light is activated. Such a method is generally known.

In the known method the passage of a vehicle is detected using induction loops in the road surface, while activation of the red light is detected by means of a current or voltage measurement in the traffic light. If a passage is detected during the period the red light is activated, this is a violation. A camera is then activated which makes one or more records of the vehicle committing the violation. These records are later examined and form the basis for imposing a sanction on the holder of the vehicle registration.

A problem which occurs in the known method is that the red light is not always visible during the red light period. This occurs particularly in modern traffic lights where instead of a light bulb use is made of an array of light-emitting diodes (LEDs) with which a better visibility is achieved at a lower energy consumption. These LEDs are powered with alternating current and so are periodically switched on and off at such a high frequency that this is not perceptible to the human eye. However, in view of the short shutter times required to make sharp records of moving vehicles, there is the danger of a record being made precisely in the short interval that the LEDs are switched off. In that case no proof of the violation can be found in the record, since it does not show that the light of the traffic light is on red.

The invention now has for its object to provide a method with which this problem is obviated. According to the invention this is achieved in an method as described above in that there is detected for which part of the activation period the red light is actually on, and the at least one record is made in precisely that part of the activation period. By thus not taking the activation period of the red light as starting point but by detecting the light is actually burning or on, it is possible to ensure that proof of the offence can be found in any record.

Preferably applied variants of the method according to the invention are described in the sub-claims 2-5.

The invention also relates to a device for performing the method. A conventional control of a red-light camera at a traffic light is provided with first means for detecting vehicles passing through the traffic light, second means for detecting a period in which the red light of the traffic light is activated, and means connected to the first and second detecting means for generating a recording signal when a vehicle passes during an activation period. The control according to the present invention is now characterized by means for determining during which part of the activation period the red light is actually burning, and means connected thereto for controlling the moment in time at which the generated recording signal is transmitted to the red-light camera.

Preferred embodiments of the device according to the invention form the subject-matter of the sub-claims 7-13.

The invention is now elucidated on the basis of an embodiment, wherein reference is made to the annexed drawing, in which:

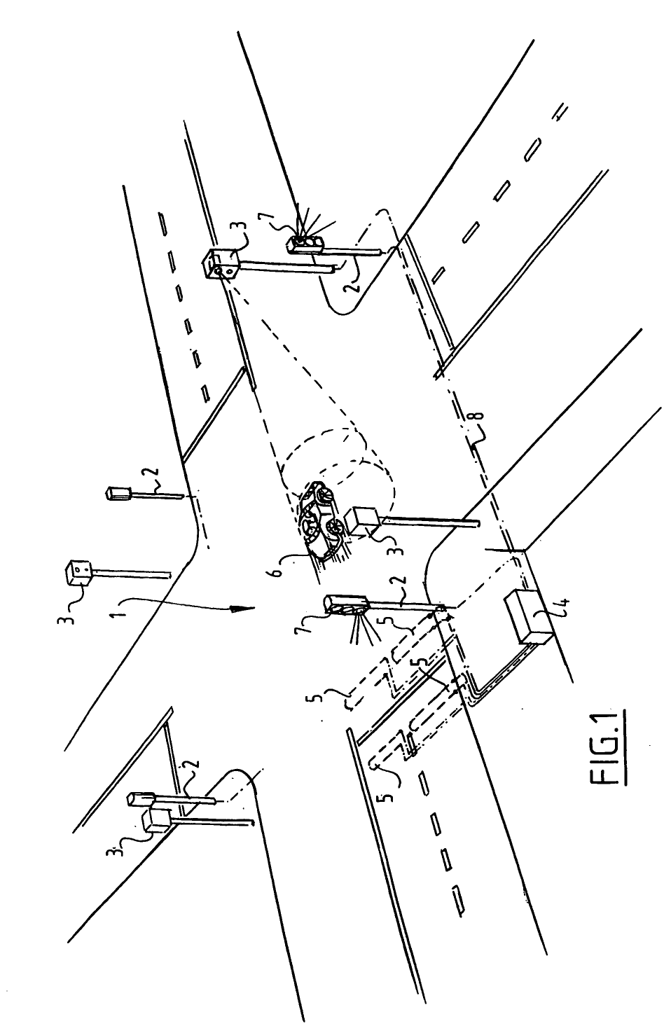

FIG. 1 shows a schematic perspective view of an arrangement of a red-light camera at an intersection monitored by traffic lights,

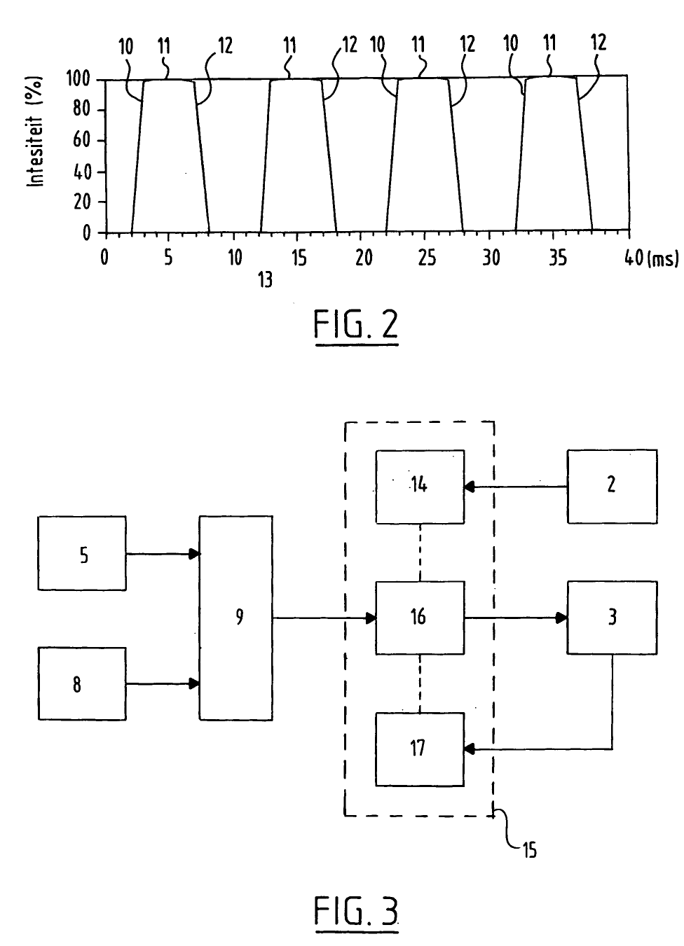

FIG. 2 shows schematically the progression of the light intensity as a function of time in a lamp based on periodically switched LEDs,

FIG. 3 shows schematically the most important elements of the control device according to the invention,

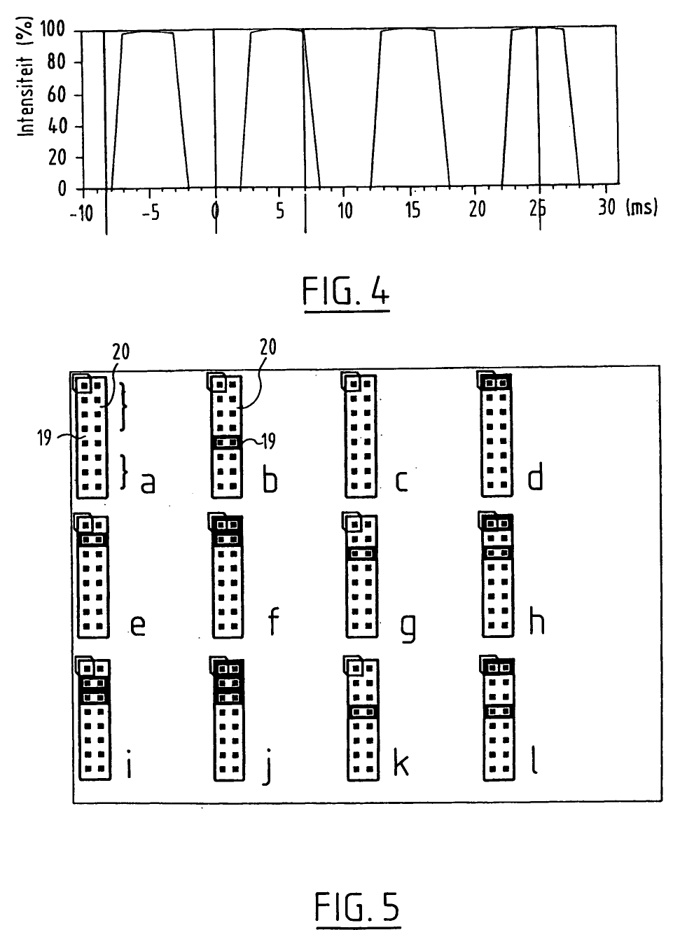

FIG. 4 shows the moment at which the recording signal must be generated to ensure a correct recording, and

FIG. 5a-l show different settings of delay means.

A number of red-light cameras 3 are placed at an intersection 1 monitored by traffic lights 2 (FIG. 1). Each red-light camera 3 is controlled by a control device 4. Each control device 4 comprises first means 5 for detecting the passage of vehicles 6, in the form of induction loops in the road surface. Each control device 4 further has second means 8, connected to the associated traffic light 2 or in any case to the control or the power supply thereof, for detecting when the red light 7 thereof is activated. In addition, control device 4 has means 9, connected to the first and second detecting means 5, 8, for generating a recording signal 18 when a vehicle 6 passes during an activation period.

Just as other lights of traffic light 2, the red light 7 consists of a large number of LEDs which are together switched in intermittent or flashing manner in accordance with the alternating current with which they are powered. This alternating current is herein rectified, whereby the frequency with which the LEDs are switched on and off amounts to double the alternating frequency. With a mains supply with a frequency of 50 Hz, the frequency at which the LEDs are switched on and off therefore amounts to 100 Hz, and the period thus amounts to 10 ms. This variation is not visible to the eye, so that the red light 7 appears to burn continuously. The shutter time of red-light cameras 3 is however so short that there is the danger of a record being made in the interval between two light pulses.

The light intensity of each light formed by the LEDs, shown with the full line in FIG. 2, has as stated a pulse-like progression which varies from zero to hundred percent. Each pulse has an ascending flank 10, a practically flat top 11 and a descending flank 12, followed by a rest interval 13. The ascending flank 10 is found to start 2 ms after the mains supply has passed zero, and to last 1 ms. The peak 11 of the intensity is thus reached 3 ms after passing zero, and lasts 4 ms. The ideal moment to make the recording is roughly halfway through the period of maximum light intensity, so about 5 ms after the passage through zero. It is in any case necessary to prevent the recording being made at a lesser light intensity, and of course not at all during an interval 13 between two successive light pulses.

Control device 4 is provided for this purpose with means 14 for determining when the red light actually burns and means 15 for controlling the moment in time at which the generated recording signal 18 is transmitted to red-light camera 3. These determining means 14 are adapted to detect when the red light 7, which flashes with a frequency of 100 Hz, comes on. For this purpose the determining means 14 here comprise an element which detects when the mains supply of traffic light 2 passes zero. This zero passage 22 is transmitted to the time control means 15. These latter comprise an adjustable delaying element 16 with which it is possible to compensate on the one hand the interval of time between the zero passage 22 and reaching maximum light intensity 11 and on the other the interval of time between the moment of generating the recording signal 23 to red-light camera 3 and the moment 24 that the record is actually made.

As stated, the first-stated interval of time is associated with the frequency of the alternating current with which the red light 7 is powered. This frequency, and therewith the flashing period, can be inputted once-only into control device 4, but it is also possible to envisage this being separately determined each time on the basis of the detected zero passages. In the delaying element 16 the recording signal 21 is thus in any case held half a period so that recording 23 coincides precisely with the peak 11 of the light intensity.

In practice however, the recording signal 21 has to be held even longer by delaying element 16 because the recording is not made immediately at the moment the recording signal 21 reaches red-light camera 3. This is caused by the slowness in the mechanical elements of red-light camera 3. Recording signal 21 must therefore be transmitted by the delaying element with a delay t_{D} such that the sum of the delay t_{D} and the response time t_{R} of camera 3 equals an integer multiple of the period of the light pulse increased by half a period. In other words, from the moment it is detected that the mains supply passes zero, it takes a further (n+0.5) times a period before the recording 24 is made. Thus is ensured that the recording is made halfway along the peak 11 of the light intensity.

Because the response time t_{R} of red-light camera 3 is not constant, but can vary due to inter alia temperature influences, the time control means 15 have an element 17 connected to red-light camera 3 for measuring the response time t_{R} thereof, which measuring element 17 is connected to the adjustable delaying element 16.

Measuring element 17 can be connected to the so-called x-contact of camera 3 which is also used to activate a flashlight forming part of camera 3.

Determining of the response time t_{R} of red-light camera 3 can be repeated with each recording, although it is also possible to only do this periodically, by generating a test signal at set intervals.

The time control means 15 can otherwise be adapted to sample the flashing period of red-light camera 3 by for instance dividing this period into 64 fractions. Recording signal 21 can then be transmitted with the desired delay in the form of a recording pulse 23 which is only allowed to pass in a determined fraction of the period.

Instead of an automatically set delay based on previously measured values of the response time of camera 3, it is also possible to manually adjust one or more delays, based for instance on the specifications of red-light camera 3 or on the results of previous measurements. Use can be made for this purpose of so-called jumpers 18. These have a region 19 for automatic adjustment of the delay and a region 20 for the manual adjustment. Through adjustment the applied delay can be varied between 0 and 10 ms.

Although the invention is elucidated above with reference to an embodiment, it is not limited thereto, but can be varied in many ways within the scope of the following claims.

1. A method for controlling a red-light camera at a traffic light by detecting vehicles which pass through the traffic light and making at least one recording when a vehicle passes during a period in which the red light of the traffic light is activated, is comprising detecting which part of the activation period the red light is on, and generating at least one record that is made in precisely that part of the activation period.

2. The method of claim 1, wherein said red light burns in flashing manner during the activation period, wherein the moment that the red light comes on is detected in the case of at least some of the flashes and therefrom is determined the moment at which the at least one recording is made.

3. The method of claim 2, characterized in that the red light is powered by an alternating current, at least one zero passage of the alternating current is detected, and on the basis of the at least one detected zero passage a recording signal generated when the vehicle passes and is transmitted to the red-light camera.

4. The method of claim 3, wherein said recording signal is corrected for a response time of the red-light camera.

5. The method of claim 4, wherein said characterized in that the response time is determined each time a recording is made, and the subsequent recording signal is corrected for the thus determined response time.

6. Device for controlling a red-light camera at a traffic light, comprising a vehicle detector for detecting vehicles passing through a traffic light, an activation detector for determining a period in which the red light of the traffic light is activated, a signal generator connected to said vehicle detector and said red light detector wherein said signal generator produces a recording signal when a vehicle passes during an activation period, a red light detector for determining during which part of the activation period the red light is actually on, timing controller to generate a signal at the moment in time at which the generated recording signal is transmitted to the red-light camera.

7. The device of claim 6, wherein said red light burns in a flashing manner during the activation period, and said red light detector is adapted to detect in the case of at least some of the flashes the moment that the red light comes on and to transmit this moment to the timing controller.

8. The device of claim 7, wherein said activation detector is adapted to detect at least one zero passage of an alternating current powering the red light and to transmit the crossing of said current to the timing controller.

9. The device of claim 7 or 8, wherein said timing controller comprises a delaying element.

10. The device of claim 9, wherein said delaying element is adjustable.

11. The device of claim 10, wherein said timing controller is adapted to determine the flashing frequency of the red light and to adjust the delaying element on the basis thereof.

12. The device of claim 10 or 11, wherein said timing controller is adapted to determine a response time of the red-light camera and to adjust the delaying element on the basis thereof.

13. The device of claim 12, wherein a red light camera detector is connected to the timing controller and is capable of measuring the response time of the red-light camera at each recording.
